(19) United States
(12) Patent Application Publication
(10) Pub. No.: US 2013/0287970 A1
(43) Pub. Date: Oct. 31, 2013

(54) Liquid Crystal Medium Composition and Liquid Crystal Display Using Same

(71) Applicants: Xinhui Zhong, Shenzhen (CN); Hongji Huang, Shenzhen (CN)

(72) Inventors: Xinhui Zhong, Shenzhen (CN); Hongji Huang, Shenzhen (CN)

(73) Assignee: Shenzhen China Star Optoelectronics Technology Co., LTD, Shenzhen City, Guangdong (CN)

(21) Appl. No.: 13/518,387

(22) PCT Filed: May 8, 2012
(86) PCT No.: PCT/CN2012/075159

§ 371 Date: Jun. 21, 2012

(30) Foreign Application Priority Data
Apr. 28, 2012 (CN) 201210133021.1

(51) Int. Cl. C09K 19/54; G02F 1/1334

(52) U.S. Cl. 428/1.1; 252/299.5

(57) ABSTRACT

The present invention provides a liquid crystal medium composition and a liquid crystal display using same. The liquid crystal medium composition includes a liquid crystal material, a stabilizer, and polymerizable monomers. The polymerizable monomers include at least two types of monomers, which include at least one highly reactive monomer and at least one strong anchoring monomer. The liquid crystal display includes upper and lower substrates that are arranged parallel to each other and a liquid crystal medium composition arranged between the upper and lower substrates. The liquid crystal medium composition includes two or more than two polymerizable monomers of different functionalities to mix in a reasonable manner so that balance can be reached among polymerization reaction rate, homogeneity of polymer formed thereby, and magnitude of anchoring force, all being of upgraded level. The optic quality and overall performance of a liquid crystal panel are enhanced.

### BACKGROUND OF THE INVENTION

1. Field of the Invention

The present invention relates to the field of liquid crystal displaying techniques, and in particular to a liquid crystal medium composition and a liquid crystal display using same.

2. The Related Arts

Liquid crystal used in twisted nematic (TN) or super twisted nematic (STN) liquid crystal displays is positive liquid crystal, which has a long axis that is parallel to a substrate surface when no electricity is applied thereto. The orientation of liquid crystal molecules on the substrate surface is determined by rubbing direction of an alignment layer (which is usually made of polyimide). The alignment directions of two substrate surfaces are perpendicular to each other, whereby molecules of the liquid crystal layer exhibit a continuously twisted arrangement from one substrate surface to another substrate surface. When a voltage is applied, the long axis of the liquid crystal molecule tends to align in the direction of electric field. Drawbacks of the TN or STN liquid crystal display are small viewable angle and severe brightness difference and color difference at large view angles. A compensation film must be applied to correct these problems and this increases the manufacture cost of display devices.

Multi-domain vertical alignment (MVA) thin-film transistor liquid crystal display (TFT-LCD) provides an excellent solution to the view angle limitation that the TN or STN displays are subjected to and uses negative liquid crystal and vertical alignment film. When no voltage is applied, the long axis of liquid crystal molecule is perpendicular to the substrate surface. Application of voltage would cause the liquid crystal molecule to tilt, making the long axis of the liquid crystal molecule aligning in a direction perpendicular to the electric field. To overcome the view angle problem, a pixel is divided into multiple domains and liquid crystal molecules are caused to tilt in different directions so that the display can provide similar viewing effect at various directions. Several ways can be adopted to have liquid crystal molecules of different domain of a pixel oriented in different direction. The first way is to form bumps on upper and lower substrate of an LCD by means of exposure development in order to cause a pre-tilt angle for liquid crystal molecules around the bumps and thus guiding the liquid crystal molecules to tilt to predetermined directions. The second way is to form ITO pixel electrodes that are of predetermined patterns on upper and lower substrates so that an electric field so induced shows a predetermined tilt angle thereby controlling the orientation of the liquid crystal molecules in different domains. This technique is often referred to as patterned vertical alignment (PVA). The third way is to form ITO slits on a TFT side of an LCD substrate, while an opposite side remains a full ITO. Polymerizable monomer can be added in the liquid crystal medium. An electric field is first applied to cause tilting of the liquid crystal molecules and then radiation of ultraviolet ray is applied to polymerize the monomers to form polymerized particles that guides tilting of the liquid crystal molecules. The particles are deposited on the substrate surface to realize an effect of alignment. This technique is the so-called polymer stabilized vertical alignment (PSVA).

Reaction rate of the polymerizable monomers and size and distribution, homogeneity on substrate surface, and magnitude of anchoring force of the polymerized bodies are factors that are of vital importance to optic quality and stability of mass production. Besides being affected by processing conditions, a major cause that affects these factors is molecular structure of the polymerizable monomer, because the molecular structure of the polymerizable monomer can determine the rate of optic reaction, the characteristics of the polymer so formed, and the magnitude of the liquid crystal anchoring force. It is often that a single type of monomer cannot make all of these factors in favorable conditions and it becomes dilemma. For example, polymer so formed may be of excellent homogeneity, but is insufficient in anchoring force, or a strong anchoring force may be obtained but the reaction rate is slow.

### SUMMARY OF THE INVENTION

An object of the present invention is to provide a liquid crystal medium composition, which comprises two or more than two polymerizable monomers of different functionalities to mix in a reasonable manner so that balance can be reached among polymerization reaction rate, homogeneity of polymer formed thereby, and magnitude of anchoring force, all being of upgraded level.

Another object of the present invention is to provide a liquid crystal display, which uses a liquid crystal medium composition that comprises two or more than two polymerizable monomers of different functionalities to mix in a reasonable manner so that balance can be reached among polymerization reaction rate, homogeneity of polymer formed thereby, and magnitude of anchoring force, all being of upgraded level, and thus, the optic quality and overall performance of a liquid crystal panel is enhanced and stable overall mass production can be realized.

To achieve the objects, the present invention provides liquid crystal medium composition, comprising: a liquid crystal material, a stabilizer, and polymerizable monomers. The polymerizable monomers comprising at least two types of monomers, which comprise at least one highly reactive monomer and at least one strong anchoring monomer.

The highly reactive monomer is represented by formula I or II:

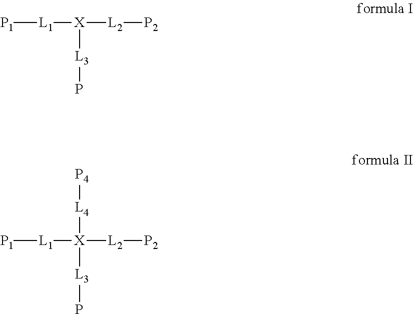

in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms.

The strong anchoring monomer is represented by formula III:

P₁-L₁-X-L₂-M formula III

in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁.

In formula I, X represents:

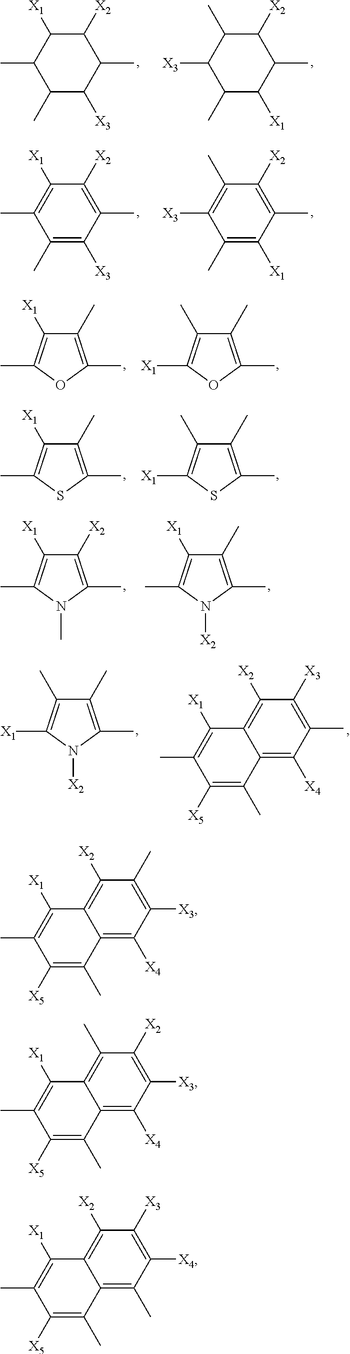

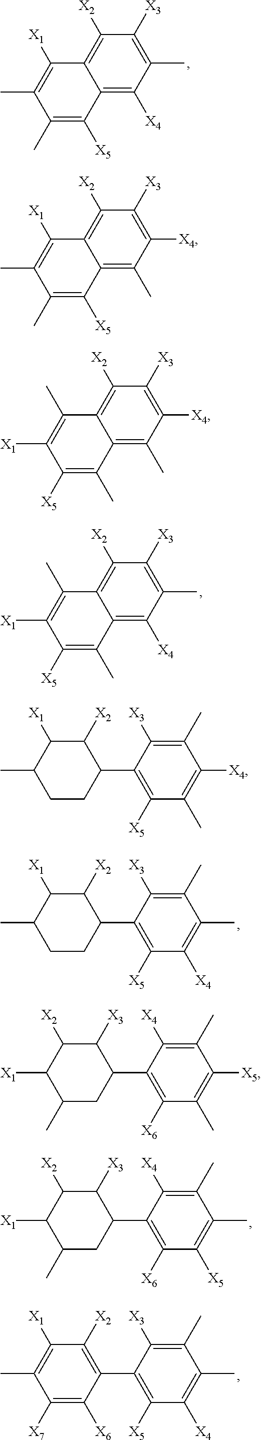

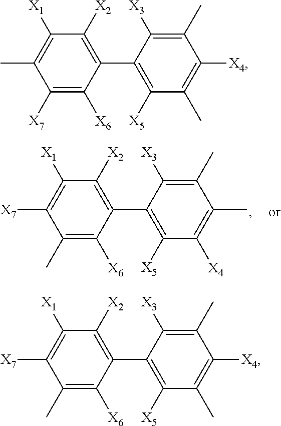

in which X₁, X₂, X₃, X₄, X₅, X₆, and X₇ are H, F, Cl, Br, CN or methyl.

In formula II, X represents:

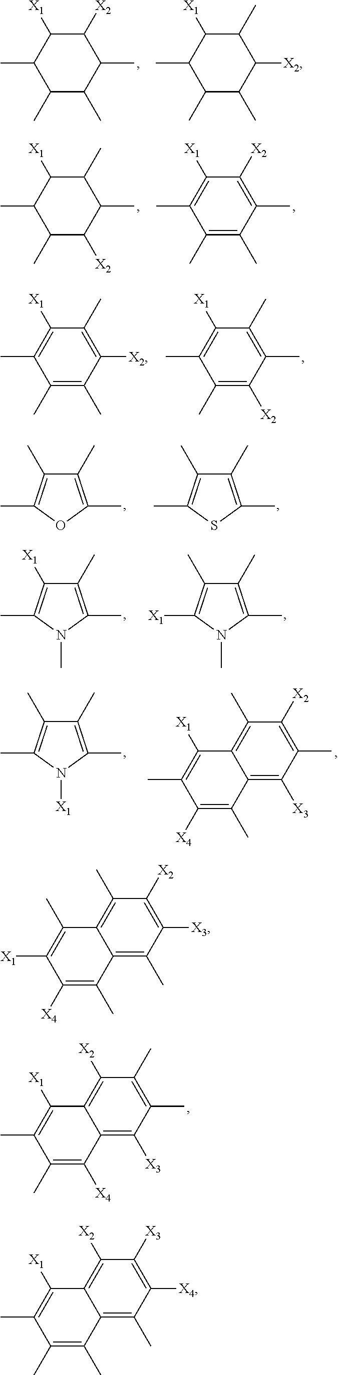

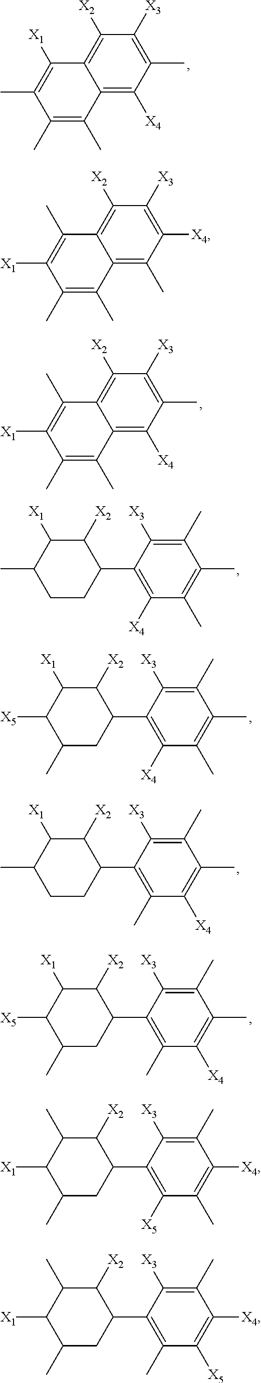

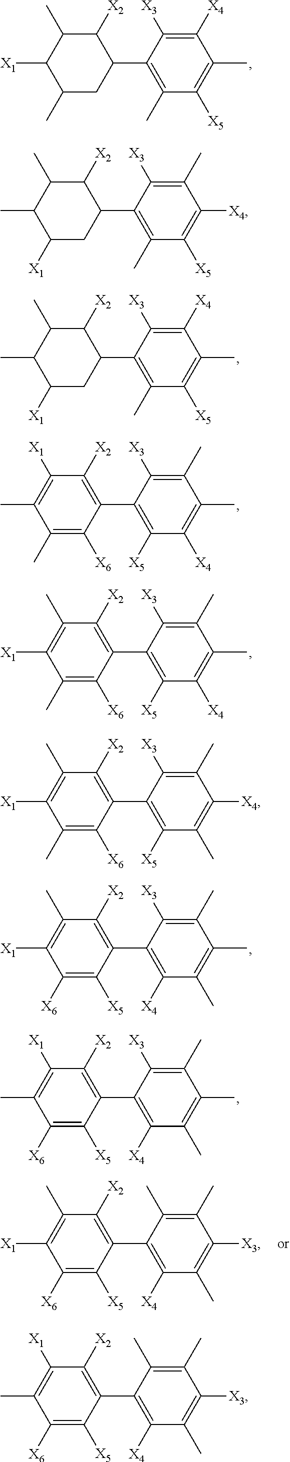

in which X₁, X₂, X₃, X₄, Xs, and X₆ are H, F, Cl, Br, CN or methyl.

In formula III, X represents:

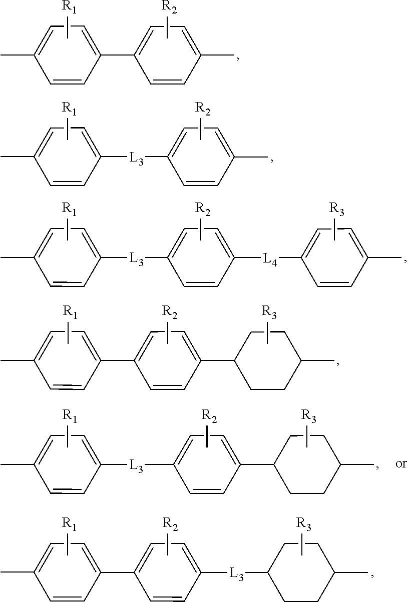

in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl.

The polymerizable monomers are in an amount of 0.1-1% by weight based on total weight of the liquid crystal medium composition. The molar ratio of highly reactive monomer to strong anchoring monomer is 5:100 to 100:100.

The liquid crystal material comprises at least one liquid crystal molecule represented by the following formula:

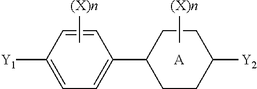

wherein

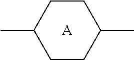

represents

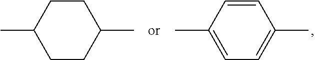

and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different.

The stabilizer comprises at least one compound represented by the following formula:

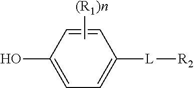

in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl.

The present invention also provides a liquid crystal display, which comprises a liquid crystal display comprising upper and lower substrates that are arranged parallel to each other and a liquid crystal medium composition arranged between the upper and lower substrates. The liquid crystal medium composition comprises: a liquid crystal material, a stabilizer, and polymerizable monomers. The polymerizable monomers comprise at least two types of monomers, which comprise at least one highly reactive monomer and at least one strong anchoring monomer.

The highly reactive monomer is represented by formula I or II:

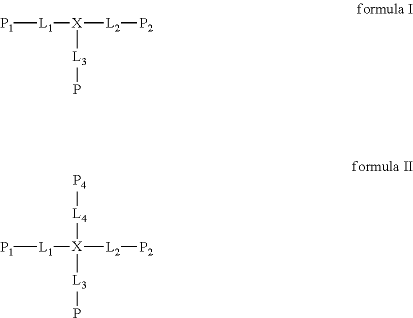

in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms;

The strong anchoring monomer is represented by formula III:

P₁-L₁-X-L₂-M formula III

in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁;

In formula I, X represents:

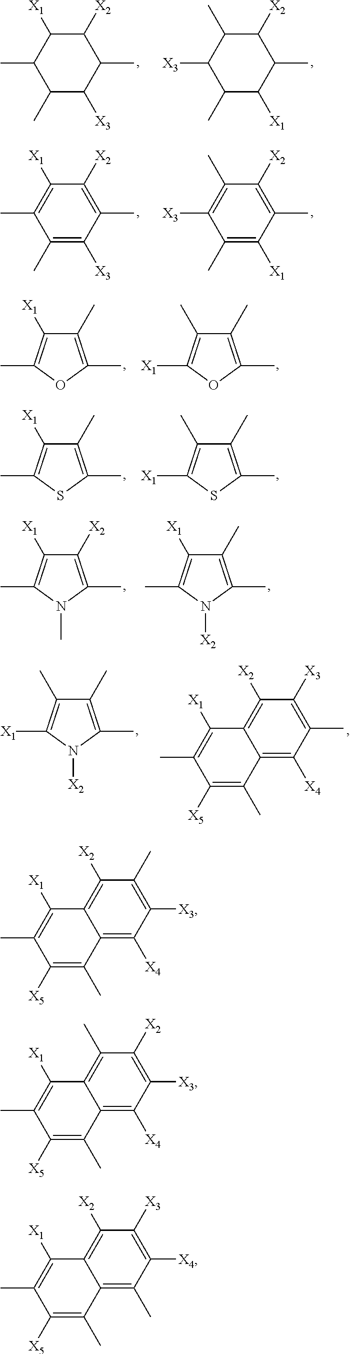

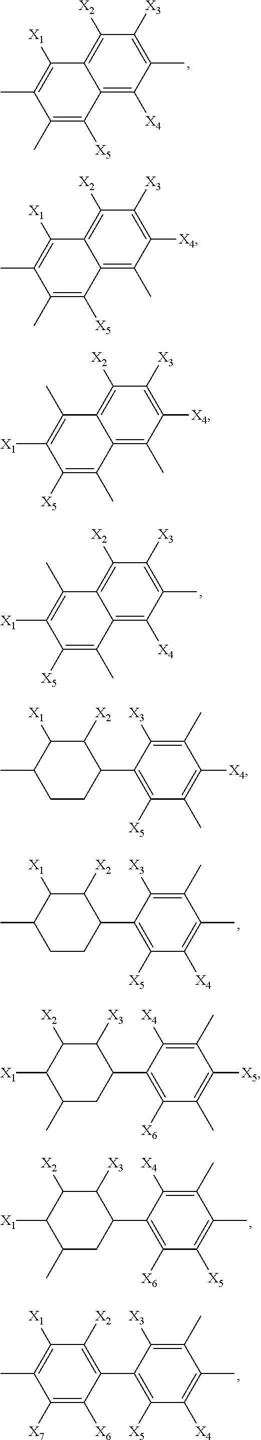

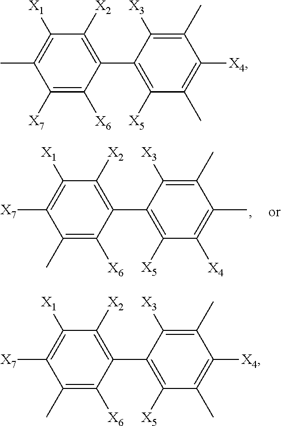

in which X₁, X₂, X₃, X₄, X₅, X₆, and X₇ are H, F, Cl, Br, CN or methyl.

In formula II, X represents:

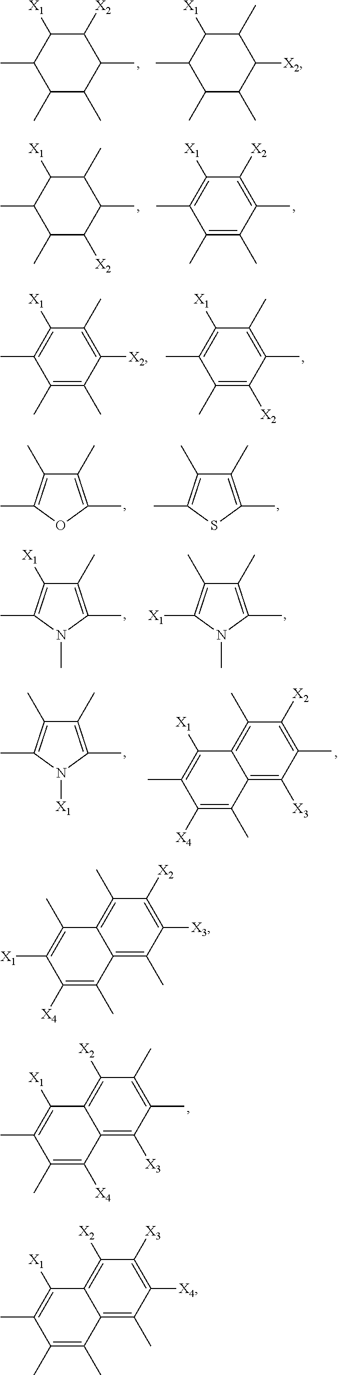

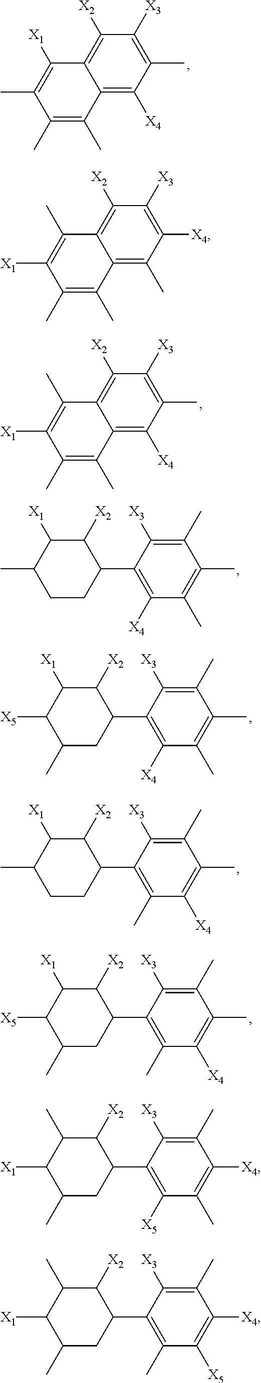

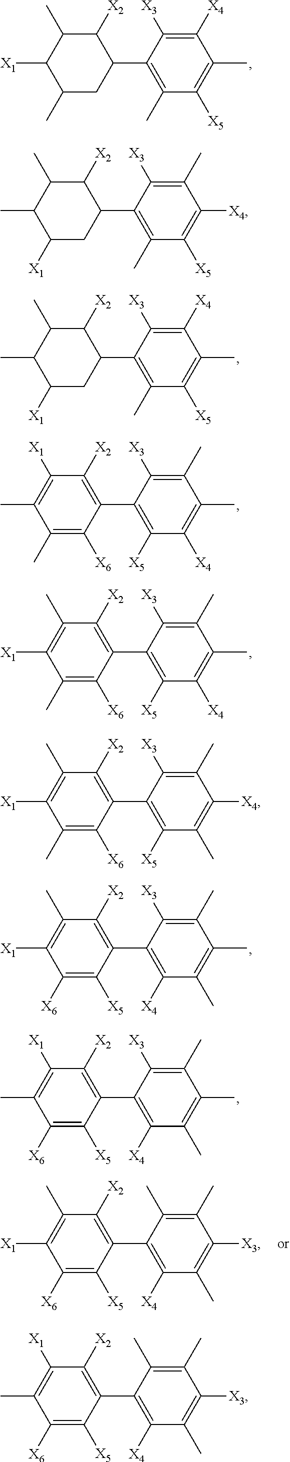

in which X₁, X₂, X₃, X₄, X₅, and X₆ are H, F, Cl, Br, CN or methyl.

In formula III, X represents:

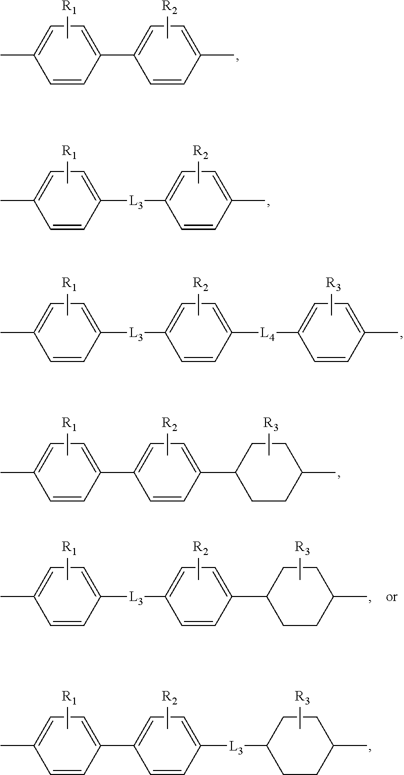

in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl.

The liquid crystal material comprises at least one liquid crystal molecule represented by the following formula:

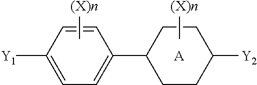

wherein

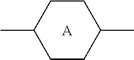

represents

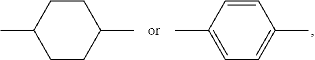

and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different.

The stabilizer comprises at least one compound represented by the following formula:

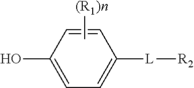

in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl.

The efficacy of the present invention is that the present invention provides a liquid crystal medium composition comprising two or more than two polymerizable monomers of different functionalities to mix in a reasonable manner so that balance can be reached among polymerization reaction rate, homogeneity of polymer formed thereby, and magnitude of anchoring force, all being of upgraded level. In application to a liquid crystal display, the optic quality and overall performance of the liquid crystal display are enhanced and stable mass production can be realized.

### DETAILED DESCRIPTION OF THE PREFERRED EMBODIMENTS

The present invention provides a liquid crystal medium composition comprising a liquid crystal material, a stabilizer, and polymerizable monomers. The polymerizable monomers comprise at least two types of monomers, which comprise at least one highly reactive monomer and at least one strong anchoring monomer. With the polymerizable monomers of different functionalities being used in combination, balance can be reached among polymerization reaction rate of the polymerizable monomers, homogeneity of polymer formed thereby, and magnitude of anchoring force, all being of upgraded level. In other words, while the polymerization reaction rate is made fast, the homogeneity and anchoring force of the polymers so formed are also improved. The polymerizable monomers are in an amount of 0.1-1% by weight based on total weight of the liquid crystal medium composition, and the molar ratio of highly reactive monomer to strong anchoring monomer is 5:100 to 100:100.

The highly reactive monomer is represented by formula I or II:

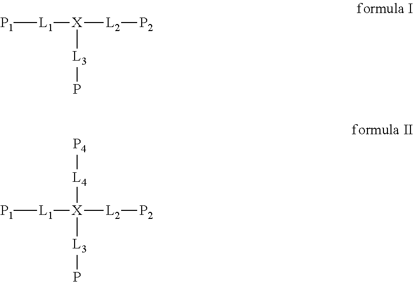

in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms.

In formula I, X represents:

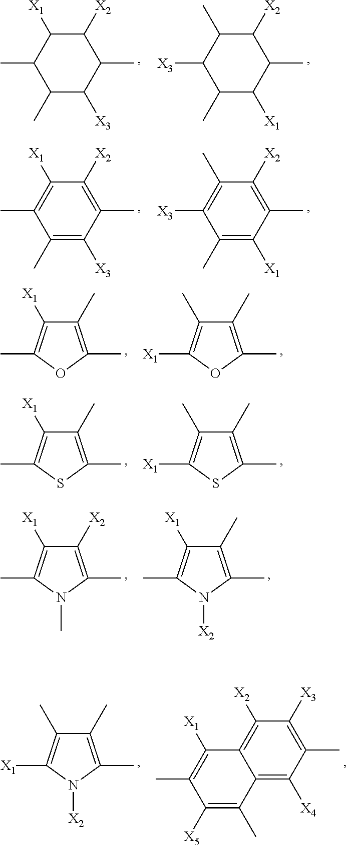

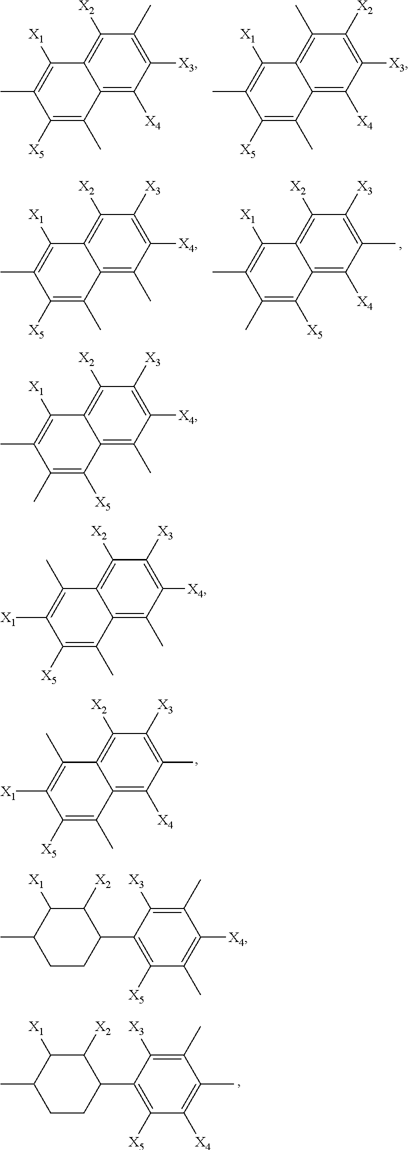

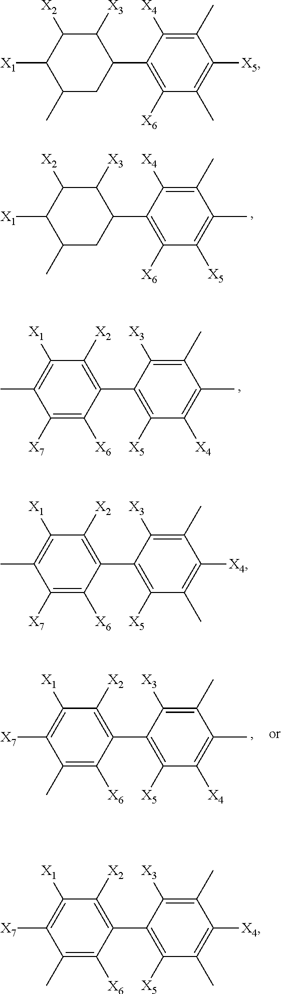

in which X₁, X₂, X₃, X₄, X₅, X₆, and X₇ are H, F, Cl, Br, CN or methyl, but X is not limited to what listed above.

In formula II, X represents:

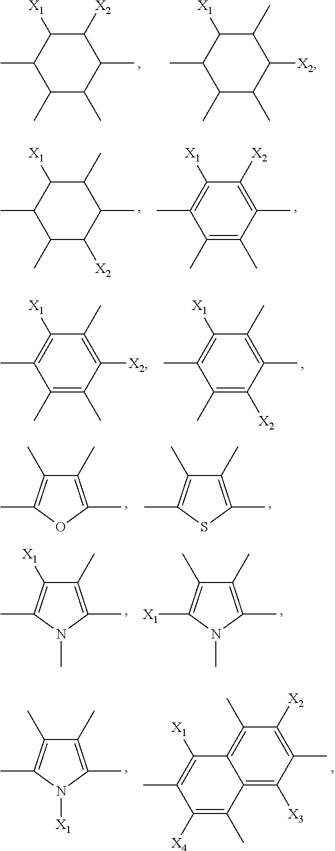

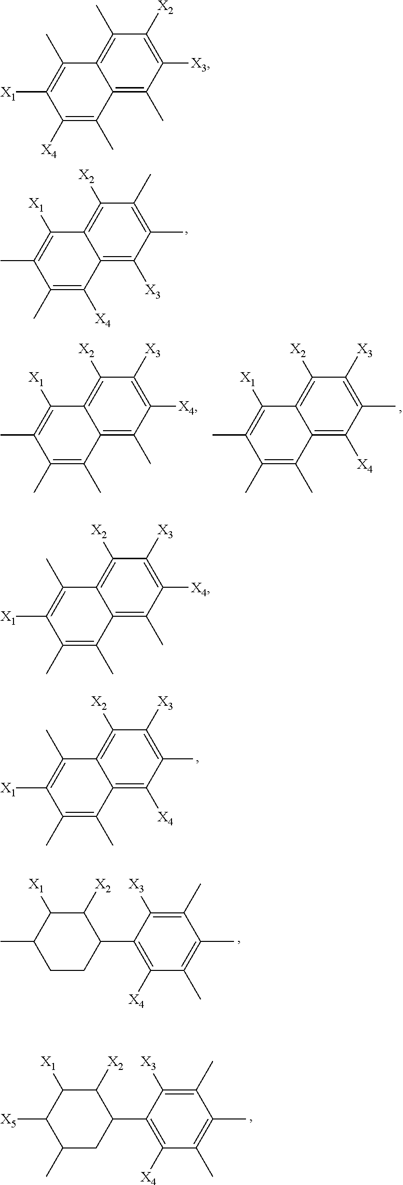

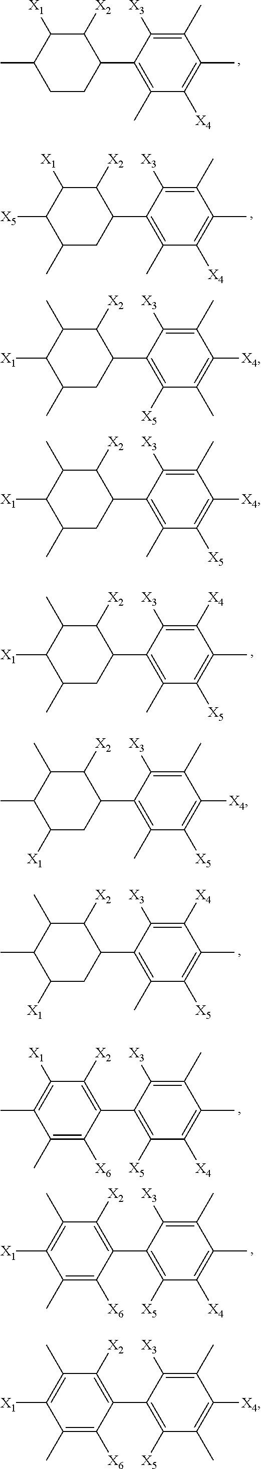

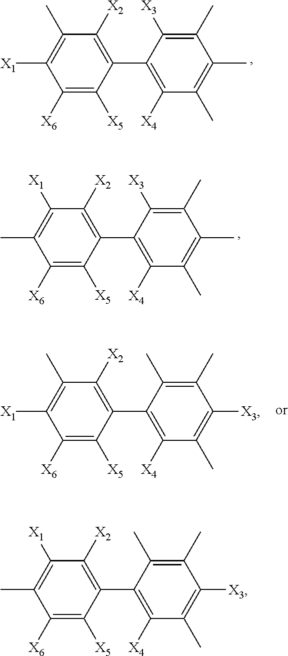

in which X₁, X₂, X₃, X₄, Xs, and X₆ are H, F, Cl, Br, CN or methyl, but X is not limited to what listed above.

The strong anchoring monomer is represented by formula III:

P₁-L₁-X-L₂-M formula III

in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁.

In formula III, X represents:

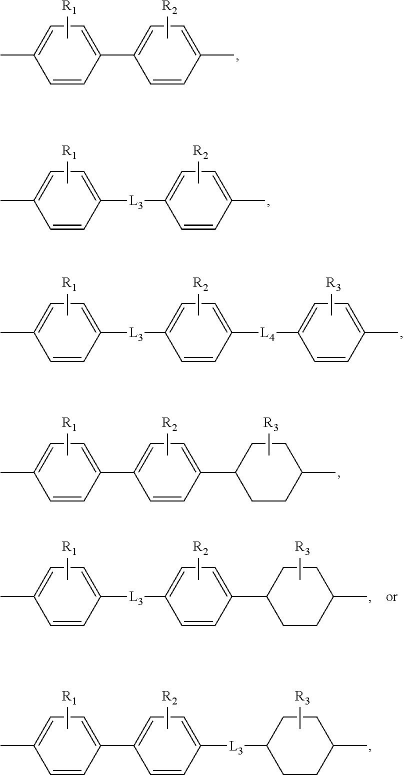

in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl, but X is not limited to what listed above.

The liquid crystal material comprises at least one liquid crystal molecule represented by the following formula:

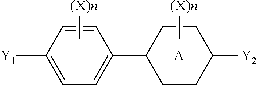

wherein

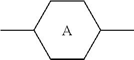

represents

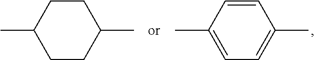

and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different. Preferably, the liquid crystal material is a negative liquid crystal material.

The stabilizer comprises at least one compound represented by the following formula:

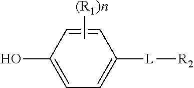

in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl.

The liquid crystal medium composition of the present invention is applicable to a display. A liquid crystal display according to the present invention that uses the above described liquid crystal medium composition comprises upper and lower substrates that are arranged parallel to each other and a liquid crystal medium composition arranged between the upper and lower substrates. The liquid crystal medium composition comprises: a liquid crystal material and polymerizable monomers. The polymerizable monomers comprise at least two types of monomers, which comprise at least one highly reactive monomer and at least one strong anchoring monomer. The liquid crystal medium composition is the liquid crystal medium composition described above and repeated description will be omitted. With the liquid crystal medium composition comprises polymerizable monomers of different functionalities, balance can be reached among polymerization reaction rate of the polymerizable monomers and homogeneity and magnitude of anchoring force of the polymer so formed thereby. In other words, while the polymerization reaction rate is made fast, the homogeneity and anchoring force of the polymers so formed are also improved. Consequently, the optic quality and overall performance of the liquid crystal display are enhanced and stable mass production can be realized.

In the following, single polymerizing monomer and dual polymerizing monomers used in combination are applied to examples to explain the practice of the present invention. In the following description, Δn indicates optic anisotropy of liquid crystal material and Δ∈ indicates dielectric anisotropy of the liquid crystal material. Tₙᵢ is the temperature of clearing point of the liquid crystal material.

### Example 1

A negative liquid crystal material is used, of which Tₙᵢ is 75° C., Δn is 0.095 (25° C., 589 nm), and Δ∈ is −2 second cooling pipe 8 (25° C., 1 kHz). A predetermined amount of the highly reactive monomer and strong anchoring monomer is mixed with the liquid crystal material to obtain a desired liquid crystal medium composition. The molar ratio of the highly reactive monomer to the strong anchoring monomer is 20:100 and the two in total take 0.35% by weight of the liquid crystal material. The highly reactive monomer used is represented by the following formula that has a molecular weight of 330:

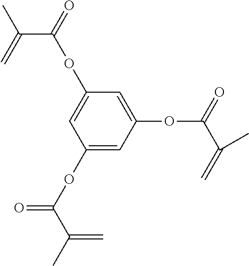 [SMILES: C=C(C)C(=O)Oc1cc(OC(=O)C(=C)C)cc(OC(=O)C(=C)C)c1]

The strong anchoring monomer used is represented by the following formula that has a molecular weight of 312:

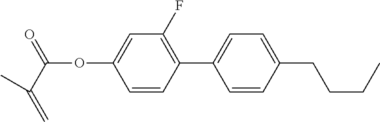 [SMILES: C=C(C)C(=O)Oc1ccc(-c2ccc(CCCC)cc2)c(F)c1]

The liquid crystal liquid crystal medium composition is applied through ODF (One Drop Filling) process to a previously formed TFT array substrate, which is then combined with a CF (Color Filter) substrate. After seal resin is cured, voltage of alternate-current square wave of 15V and 60 Hz is applied to the panel and at the same time radiation of UV light is applied to the panel to have the polymerizable monomers contained in the liquid crystal medium composition polymerized to form polymer thereby effecting alignment.

### Examples 2-5

These examples are similar to Example 1, except that different amounts of the highly reactive monomer and the strong anchoring monomer are used. Data of these examples are listed in the following Table 1.

| | | | molar |
|---|---|---|---|
| | Highly reactive monomer | | ratio of |
| | (A) | strong anchoring monomer (B) | A to B |
| Ex 2 | 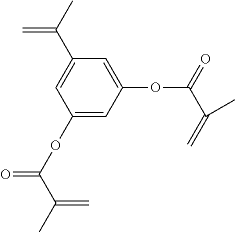 [SMILES: C=C(C)C(=O)Oc1cc(OC(=O)C(=C)C)cc(C(=C)C)c1] | 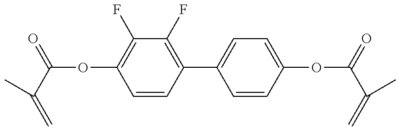 [SMILES: C=C(C)C(=O)Oc1ccc(-c2ccc(OC(=O)C(=C)C)c(F)c2F)cc1] | 50:100 |
| Ex 3 | 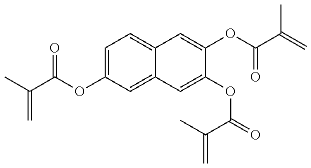 [SMILES: C=C(C)C(=O)Oc1ccc2cc(OC(=O)C(=C)C)c(OC(=O)C(=C)C)cc2c1] | 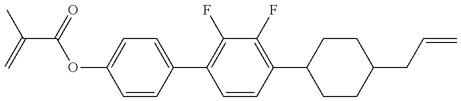 [SMILES: C=CCC1CCC(c2ccc(-c3ccc(OC(=O)C(=C)C)cc3)c(F)c2F)CC1] | 25:100 |
| Ex 4 | 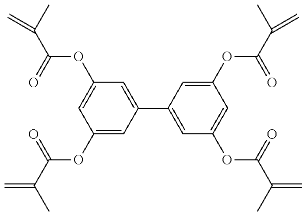 [SMILES: C=C(C)C(=O)Oc1cc(OC(=O)C(=C)C)cc(-c2cc(OC(=O)C(=C)C)cc(OC(=O)C(=C)C)c2)c1] | 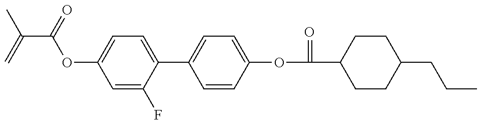 [SMILES: C=C(C)C(=O)Oc1ccc(-c2ccc(OC(=O)C3CCC(CCC)CC3)cc2)c(F)c1] | 15:100 |
| Ex 5 | 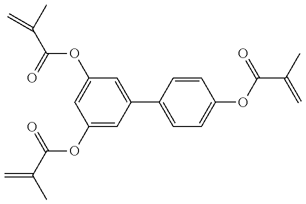 [SMILES: C=C(C)C(=O)Oc1ccc(-c2cc(OC(=O)C(=C)C)cc(OC(=O)C(=C)C)c2)cc1] | 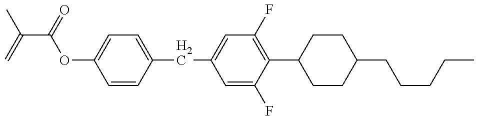 [SMILES: C=C(C)C(=O)Oc1ccc(Cc2cc(F)c(C3CCC(CCCCC)CC3)c(F)c2)cc1] | 20:100 |

In summary, the present invention provides a liquid crystal medium composition, which comprises two or more than two polymerizable monomers of different functionalities to mix in a reasonable manner so that balance can be reached among polymerization reaction rate, homogeneity of polymer formed thereby, and magnitude of anchoring force, all being of upgraded level. The liquid crystal medium composition is applicable to a liquid crystal display so that the optic quality and the overall performance of the panel are improved and stable mass production can be realized.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal medium composition, comprising: a liquid crystal material, a stabilizer, and polymerizable monomers, the polymerizable monomers comprising at least two types of monomers, which comprise at least one highly reactive monomer and at least one strong anchoring monomer;
wherein the highly reactive monomer is represented by formula I or II: 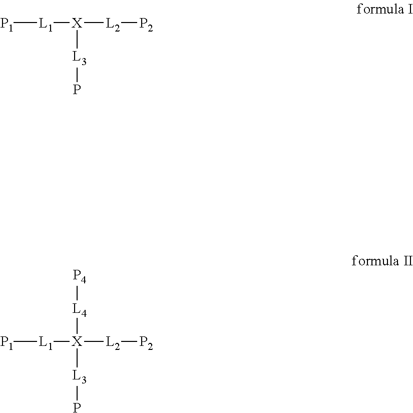
in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms;
wherein the strong anchoring monomer is represented by formula III:
P₁-L₁-X-L₂-M formula III
in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁.

2. The liquid crystal medium composition as claimed in claim 1, wherein in formula I, X represents: 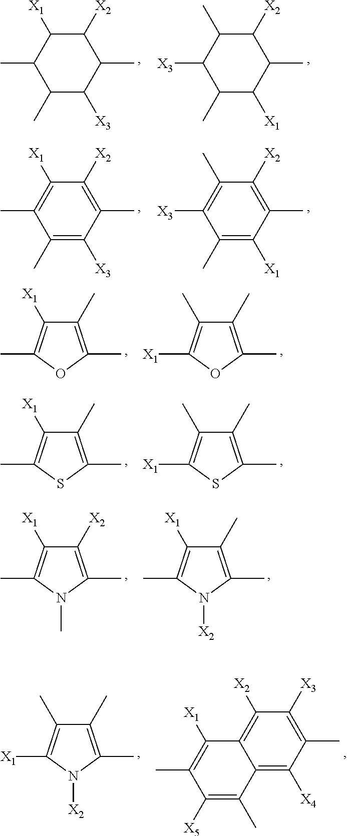 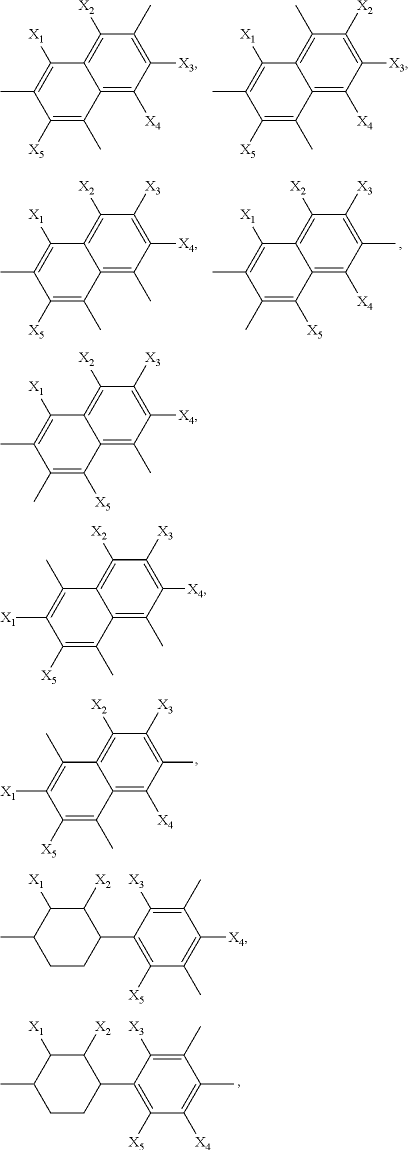 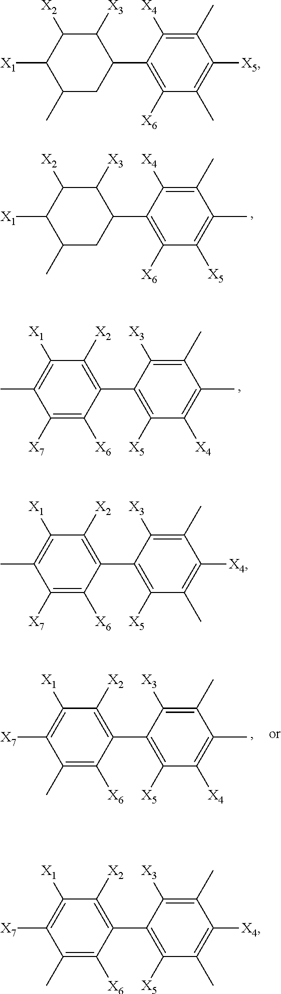
in which X₁, X₂, X₃, X₄, Xs, X₆, and X₇ are H, F, Cl, Br, CN or methyl.

3. The liquid crystal medium composition as claimed in claim 1, wherein in formula II, X represents: 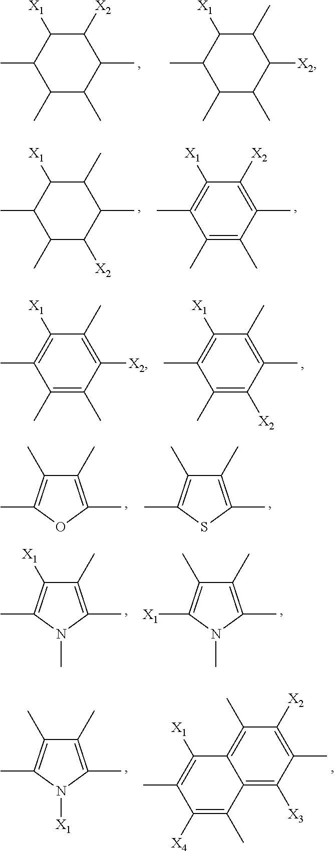 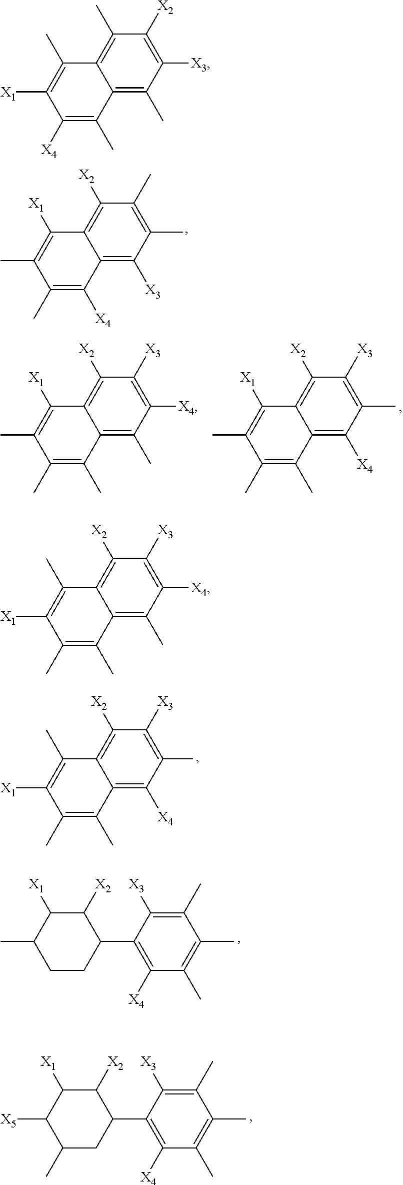 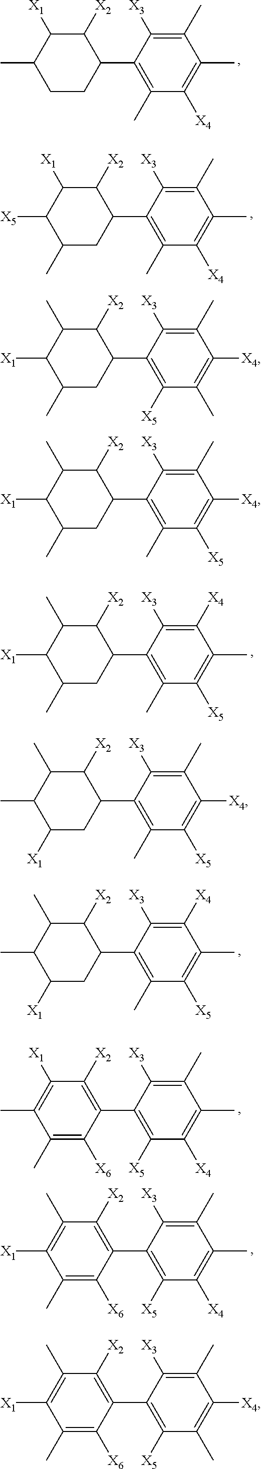 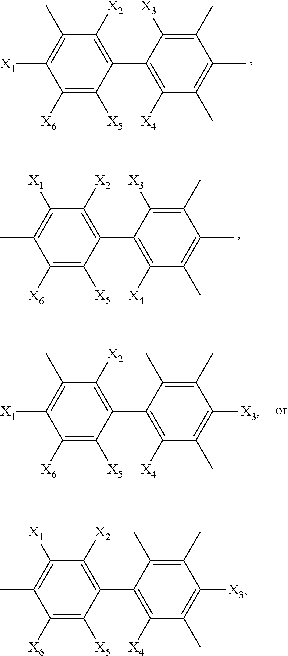
in which X₁, X₂, X₃, X₄, X₅, and X₆ are H, F, Cl, Br, CN or methyl.

4. The liquid crystal medium composition as claimed in claim 1, wherein in formula III, X represents: 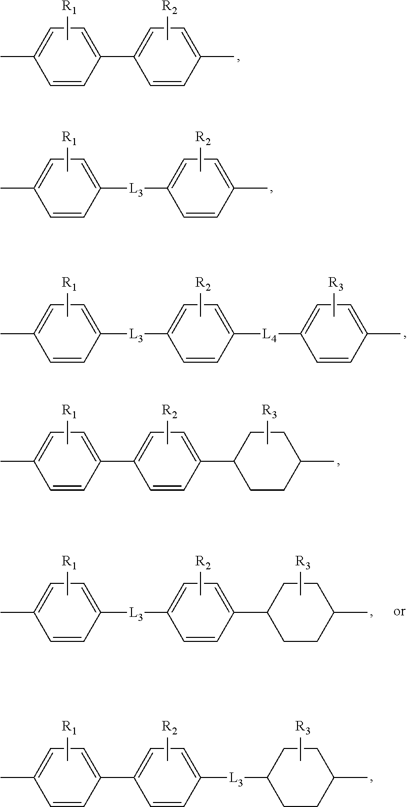
in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl.

5. The liquid crystal medium composition as claimed in claim 1, wherein the polymerizable monomers are in an amount of 0.1-1% by weight based on total weight of the liquid crystal medium composition, and the molar ratio of highly reactive monomer to strong anchoring monomer is 5:100 to 100:100.

6. The liquid crystal medium composition as claimed in claim 1, wherein the liquid crystal material comprises at least one liquid crystal molecule represented by the following formula: 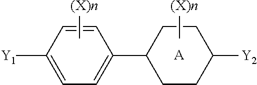
wherein 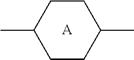
represents 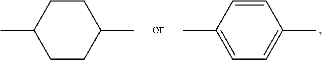
and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different.

7. The liquid crystal medium composition as claimed in claim 1, wherein the stabilizer comprises at least one compound represented by the following formula: 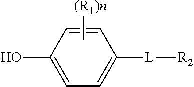
in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl.

8. A liquid crystal display comprising upper and lower substrates that are arranged parallel to each other and a liquid crystal medium composition arranged between the upper and lower substrates, the liquid crystal medium composition comprising: a liquid crystal material, a stabilizer, and polymerizable monomers, the polymerizable monomers comprising at least two types of monomers, which comprise at least one highly reactive monomer and at least one strong anchoring monomer;
wherein the highly reactive monomer is represented by formula I or II: 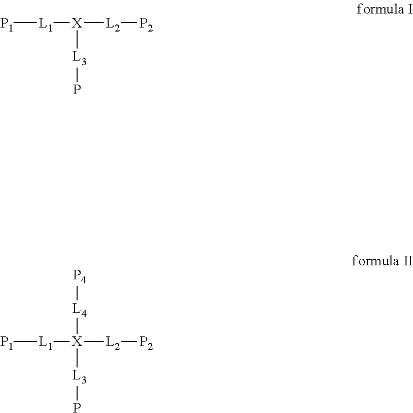
in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms;
wherein the strong anchoring monomer is represented by formula III:
P₁-L₁-X-L₂-M formula III
in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁.

9. The liquid crystal display as claimed in claim 8, wherein in formula I, X represents: 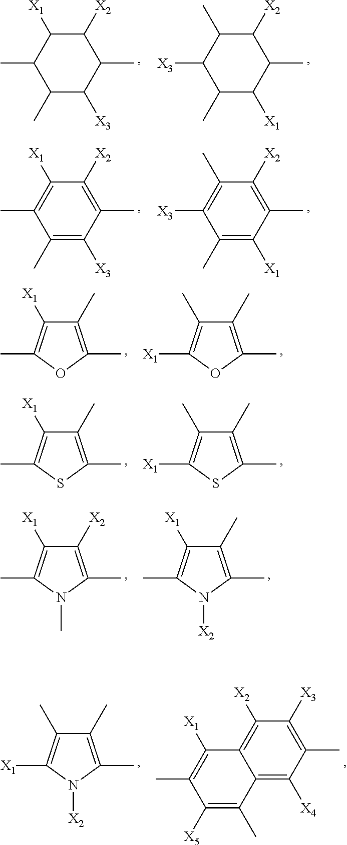 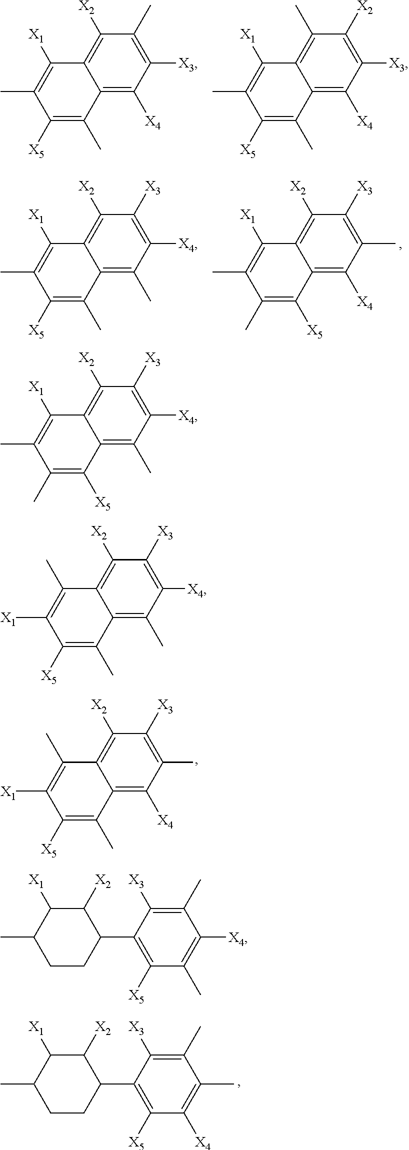 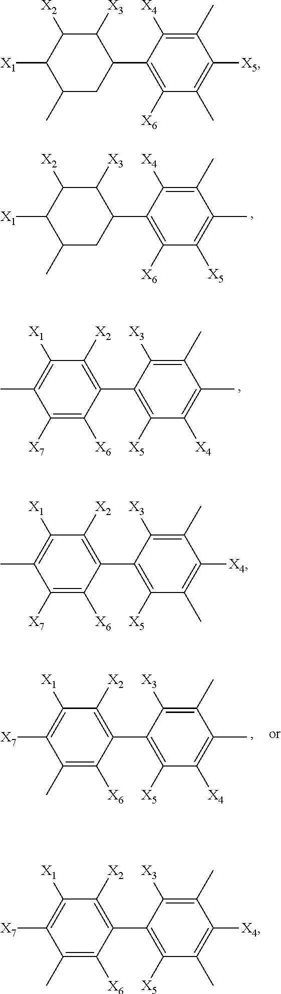
in which X₁, X₂, X₃, X₄, X₅, X₆, and X₇ are H, F, Cl, Br, CN or methyl; and in formula II, X represents: 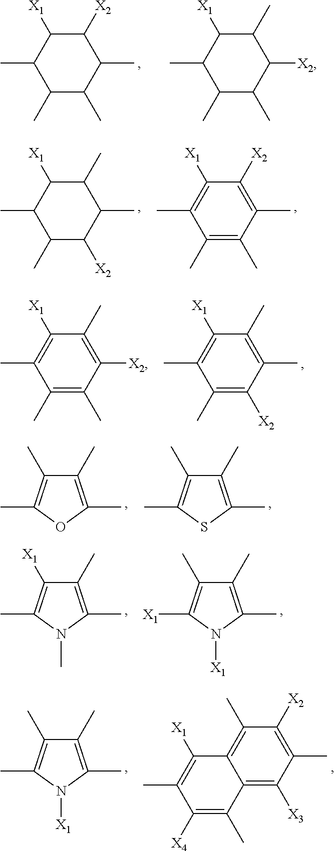 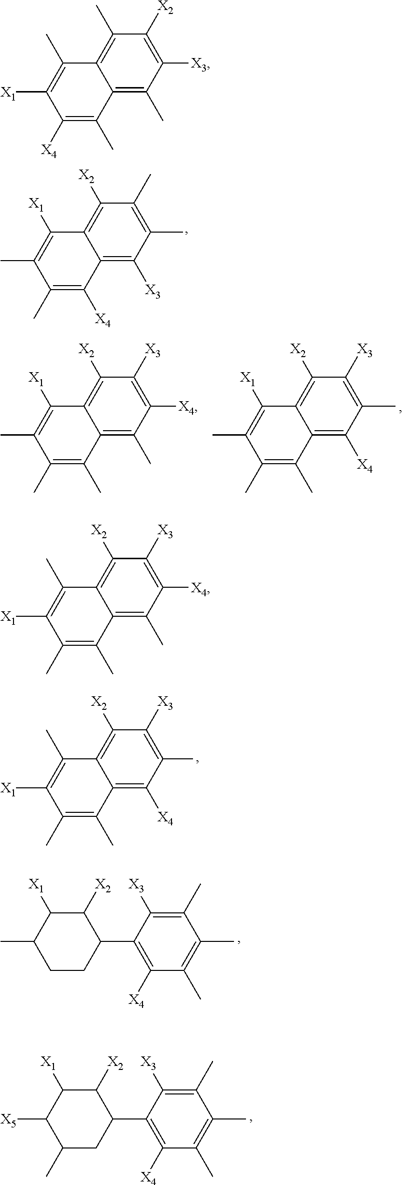 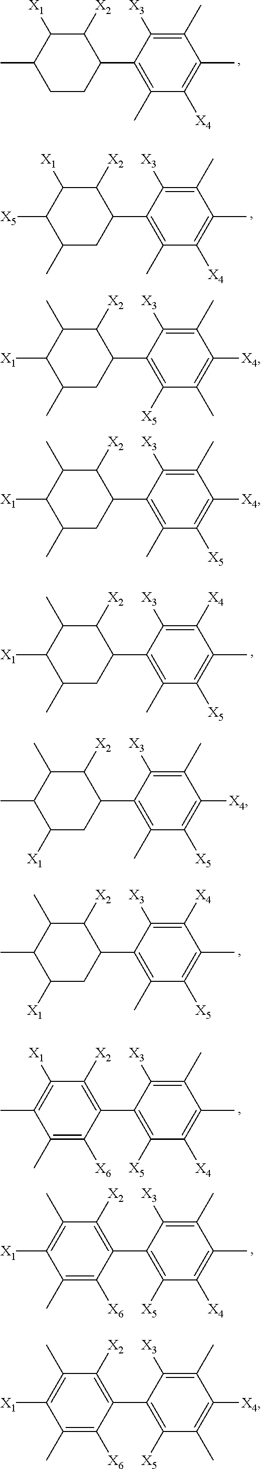 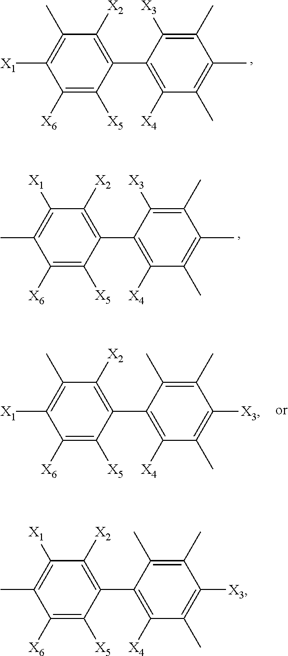
in which X₁, X₂, X₃, X₄, Xs, and X₆ are H, F, Cl, Br, CN or methyl.

10. The liquid crystal display as claimed in claim 8, wherein in formula III, X represents: 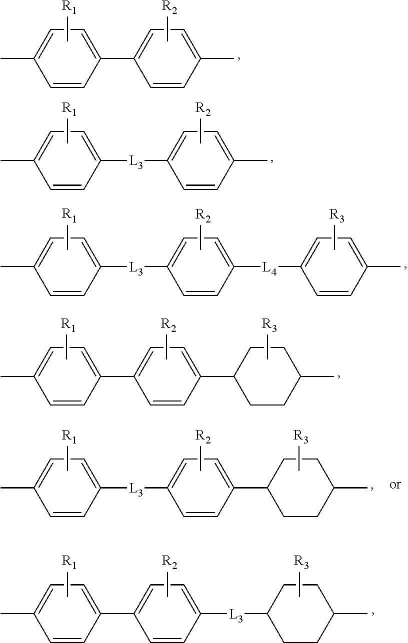
in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl.

11. The liquid crystal display as claimed in claim 8, wherein the liquid crystal material comprises at least one liquid crystal molecule represented by the following formula: 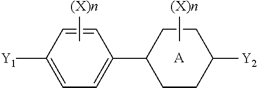
wherein 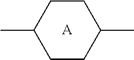
represents 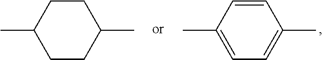
and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different.

12. The liquid crystal display as claimed in claim 8, wherein the stabilizer comprises at least one compound represented by the following formula: 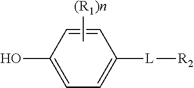
in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl.

13. The liquid crystal display as claimed in claim 8, wherein the polymerizable monomers are in an amount of 0.1-1% by weight based on total weight of the liquid crystal medium composition, and the molar ratio of highly reactive monomer to strong anchoring monomer is 5:100 to 100:100.

14. A liquid crystal display comprising upper and lower substrates that are arranged parallel to each other and a liquid crystal medium composition arranged between the upper and lower substrates, the liquid crystal medium composition comprising: a liquid crystal material, a stabilizer, and polymerizable monomers, the polymerizable monomers comprising at least two types of monomers, which comprise at least one highly reactive monomer and at least one strong anchoring monomer;
wherein the highly reactive monomer is represented by formula I or II: 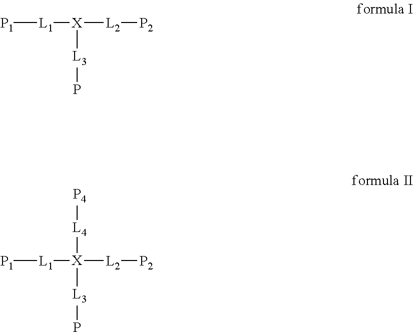
in which P₁, P₂, P₃, and P₄ represent polymerizable moieties, which, being identical or different, comprise methacrylate, acrylate, ethenyl, ethyleneoxy, or epoxy groups; L₁, L₂, L₃ and L₄ represent linking moieties, which, being identical or different, comprise single bond, —O—, —COO—, —OCO—, —CH₂O—, —OCH₂O—, —O(CH₂)₂O—, —COCH₂—, or methylenyl; X represents a core moiety comprising a five- or six-membered ring that comprises or do not comprise heteroatoms or two five- or six-membered ring that comprise or do not comprise heteroatoms;
wherein the strong anchoring monomer is represented by formula III:
P₁-L₁-X-L₂-M formula III
in which P₁ represents a polymerizable moiety which comprises methacrylate, acrylate, ethenyl, ethyleneoxy or epoxy groups; L₁ and L₂ represent linking moieties, which, being identical or different, comprise single bond, —O—, —COO—, —OCO—, —CH₂O—, —OCH₂O—, —O(CH₂)₂O—, —COCH₂— or methylenyl; X represents a core moiety comprising two benzene rings, or two benzene rings indirectly or directly para-linked with a cyclohexane; M is a C1-7 linear or branched chain alkyl, or a moiety comprising polymerizing moiety P₁;
wherein in formula I, X represents: 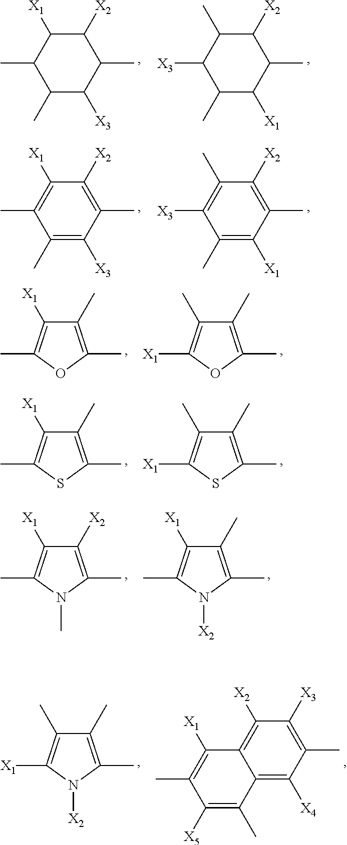 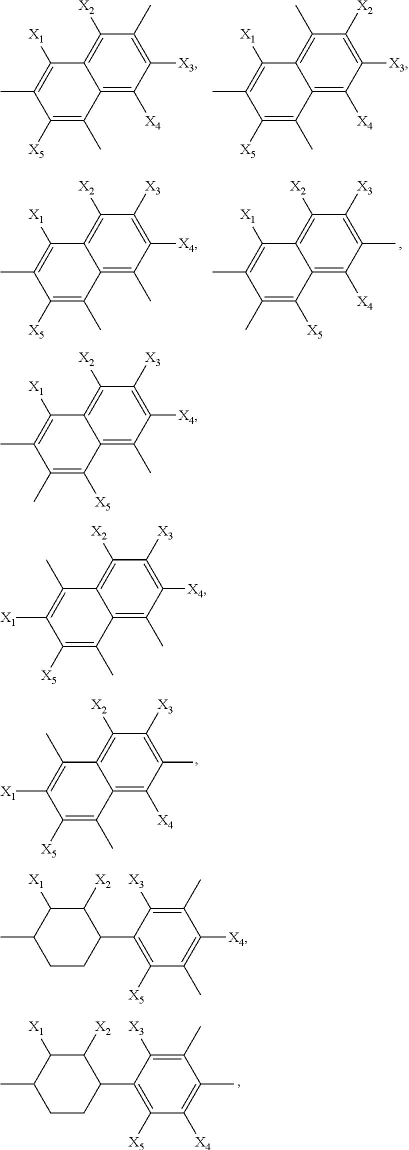 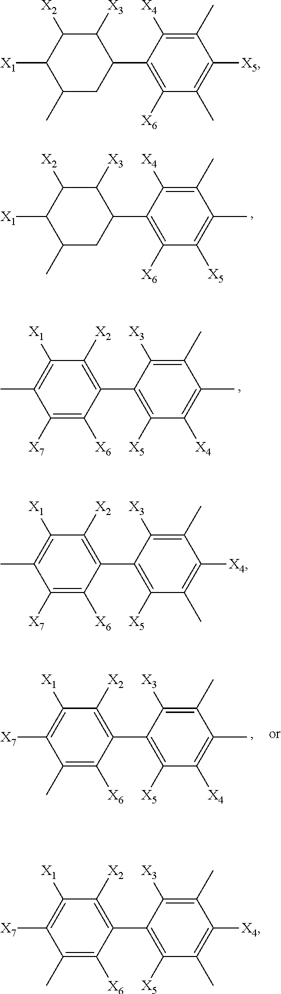
in which X₁, X₂, X₃, X₄, X₅, X₆, and X₇ are H, F, Cl, Br, CN or methyl; and in formula II, X represents: 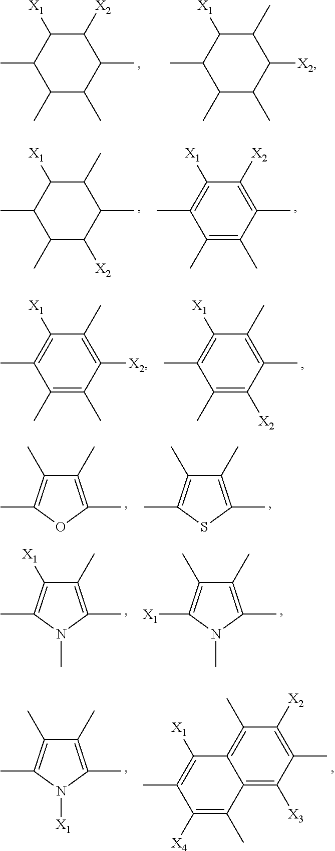 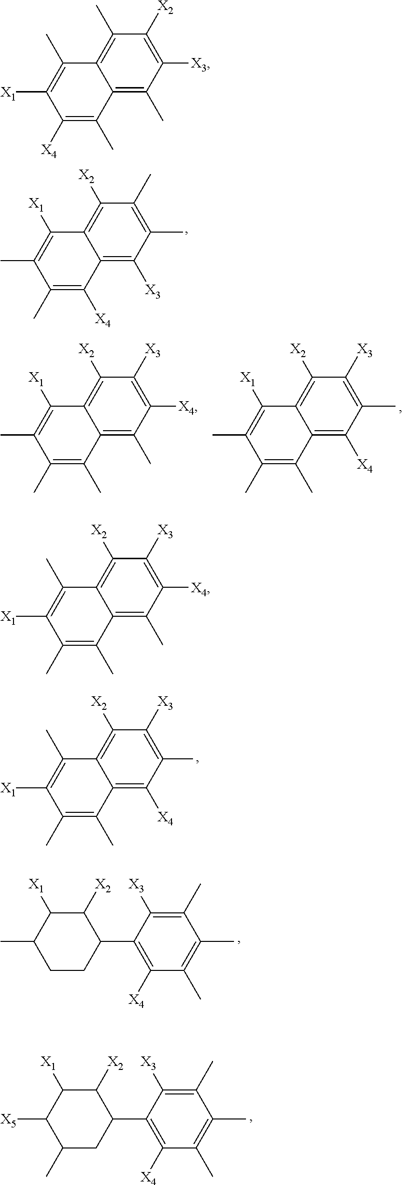 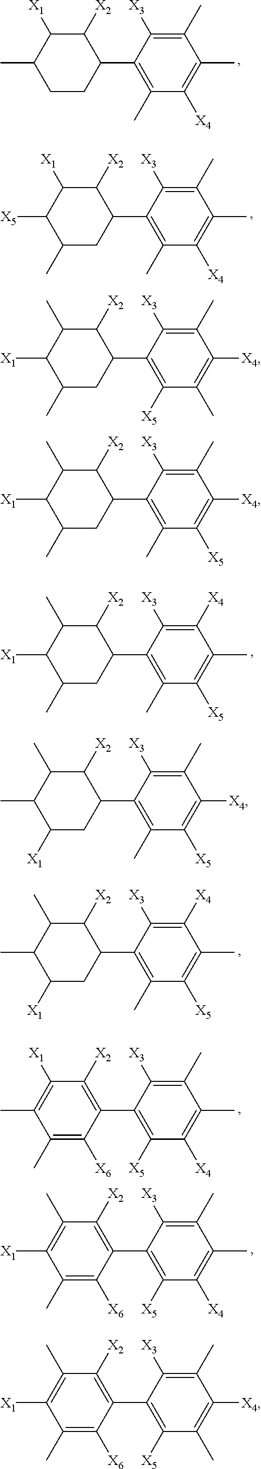 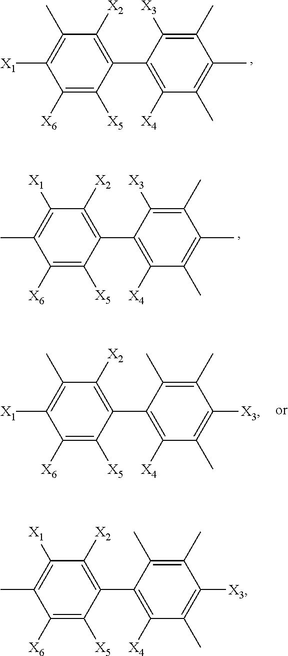
in which X₁, X₂, X₃, X₄, Xs, and X₆ are H, F, Cl, Br, CN or methyl;
wherein in formula III, X represents: 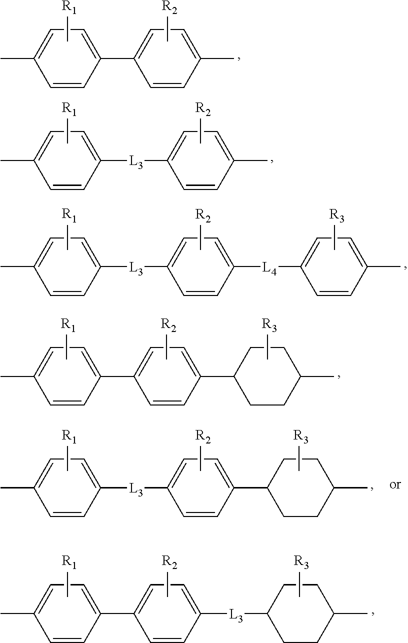
in which R₁, R₂, R₃, which, being identical or different, comprise H, F, Cl, Br, CN, methyl, or ethyl; L₃ and L₄, which, being identical or different, are single bond, —O—, —COO—, —OCO—, —CH₂O—, —OCH₂O—, —O(CH₂)₂O—, —COCH₂—, or methylenyl;
wherein the liquid crystal material comprises at least one liquid crystal molecule represented by the following formula: 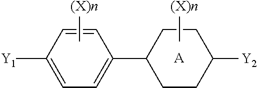
wherein 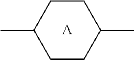
represents 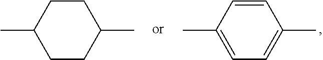
and X represents substituted moieties connected to the rings, n is an integral of 1-4, n values in each of the rings being identical or different, whereby n>1 indicates the individual ring structure has a plurality of identical or different substituted moieties X, the substituted moiety represented by X comprising —H, —F, —Cl, —Br, —I, —CN, or —NO₂, Y₁ and Y₂ being —R, —O—R, —CO—R, —OCO—R, —COO—R, or —(OCH₂CH₂)ₙ₁CH₃, in which R represents a C1-12 linear or branched alkyl, n1 is an integral of 1-5, Y₁ and Y₂ are identical or different;
wherein the stabilizer comprises at least one compound represented by the following formula: 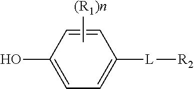
in which R₁ represents a C1-9 linear or branched alkyl, n is an integral of 1-4, n>1 indicates the individual ring structure has a plurality of substituted moieties R₁ which are identical or different, R₂ represents a C1-36 linear or branched alkyl; L is —C—C—, —O—, —COO—, —OCO—, —CH₂O—, —OCH₂O—, —O(CH₂)₂O—, —COCH₂— or methylenyl; and
wherein the polymerizable monomers are in an amount of 0.1-1% by weight based on total weight of the liquid crystal medium composition, and the molar ratio of highly reactive monomer to strong anchoring monomer is 5:100 to 100:100.
